(19) United States
(12) Patent Application Publication
(10) Pub. No.: US 2022/0382220 A1
(43) Pub. Date: Dec. 1, 2022

(54) CLOCK WITH MECHANICAL MOVEMENT MOTIF

(71) Applicant: Matthew Aaron Zufelt, Hazel Park, MI (US)

(72) Inventor: Matthew Aaron Zufelt, Hazel Park, MI (US)

(21) Appl. No.: 17/804,953

(22) Filed: Jun. 1, 2022

Related U.S. Application Data
(60) Provisional application No. 63/202,204, filed on Jun. 1, 2021.

(51) Int. Cl. G04C 3/16; G04C 3/00; G04B 1/08; G04B 13/02

(52) U.S. Cl. CPC G04C 3/16; G04C 3/008; G04B 1/08; G04B 13/02

(57) ABSTRACT

Clock with mechanical movement motif that incorporates a clock movement with a movement of a selected mechanical part. The clock may be wall mounted or may include an upright stand having a base and an attachment to a mounting frame. The mounting frame includes an adapter flange for attachment of a clock works mechanism. The movement shafts of the clock mechanism are carried through an aperture extending through a face of the mounting frame. A front face of the mounting frame includes a spindle with index notches for cooperative engagement with a clock face. A bushing has an inner diameter that is adapted to be rotationally carried on the shouldered region of the spindle. An outer diameter of the bushing is adapted to carry a bore of a mechanical part. A motor and drive sprocket are coupled to the bushing for rotation of the mechanical part about the spindle.

### CROSS-REFERENCE TO RELATED APPLICATION

This application claims the benefit of priority of U.S. provisional application No. 63/202,204 filed Jun. 1, 2021, the contents of which are herein incorporated by reference.

### BACKGROUND OF THE INVENTION

The present invention relates timepieces, and more particularly to free standing clocks.

Traditional freestanding clocks generally provide a time keeping function with a decorative motif or theme for the clock. In the automotive and mechanical parts realms, mechanical parts are combined with a clock mechanism. While the clock mechanism provides a movement for the time keeping aspects of the clock, the mechanical parts remain stationary and therefore, provide no synergy between the clock movement and the selected mechanical part. These clocks provide no indication of the movements of the selected mechanical parts and their interrelationships.

As can be seen, there is a need for an improved free standing automotive clock that provides for a clock movement and a movement of the selected automotive part.

### SUMMARY OF THE INVENTION

In one aspect of the present invention, a clock with mechanical movement motif is disclosed. The clock includes a clock mount adapted for mounting to one or more of a wall surface or an upright stand. A clock works is coupled with the clock mount and is configured for movement of an hour hand and a minute hand. A motor having a drive shaft is coupled with the clock mount. A drive gear is attached to the drive shaft of the motor. A driven sprocket is rotationally carried on a spindle and is rotationally operated by engagement with the drive gear. A rotational body is coupled with the driven sprocket for rotation therewith.

In some embodiments, a clock face is coupled with the clock mount in a fixed orientation with the clock mount in front of a rotational face of the rotational body.

In some embodiments, the rotational body is an automotive timing gear. A timing chain is suspended on the automotive timing gear. An automotive crank gear is carried by the automotive timing gear.

In some embodiments, the rotational body is a bicycle gear. A bicycle chain is supported by the bicycle gear. A bicycle hub may be carried by the bicycle gear.

In other aspects of the invention, a clock is disclosed. The clock includes a clock mount adapted for mounting to one or more of a wall surface or an upright stand. A clock works is coupled with the clock mount. The clock works is configured for movement of an hour hand and a minute hand. A motor is coupled with the clock mount. A rotational body coupled with the motor for rotation thereby. A clock face is maintained in a fixed orientation in front of the rotational body.

In some embodiments, the rotational body is an automotive timing gear. A timing gear is suspended from the automotive timing chain. A crank sprocket carried by the timing chain.

These and other features, aspects and advantages of the present invention will become better understood with reference to the following drawings, description and claims.

### BRIEF DESCRIPTION OF THE DRAWINGS

FIG. 1 is a front elevation view of a clock with mechanical movement motif.

FIG. 2 is a rear elevation view of the a clock with mechanical movement motif.

FIG. 3 is a detail elevation view of a clock mount.

FIG. 4 is a detail side view of a drive gear.

FIG. 5 is a detail side view of the clock gear.

FIG. 6 is a front elevation view of the clock face.

FIG. 7 is an exploded elevation view of the components of the invention.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide an improved free-standing clock that incorporates a clock movement with a movement of a selected mechanical part.

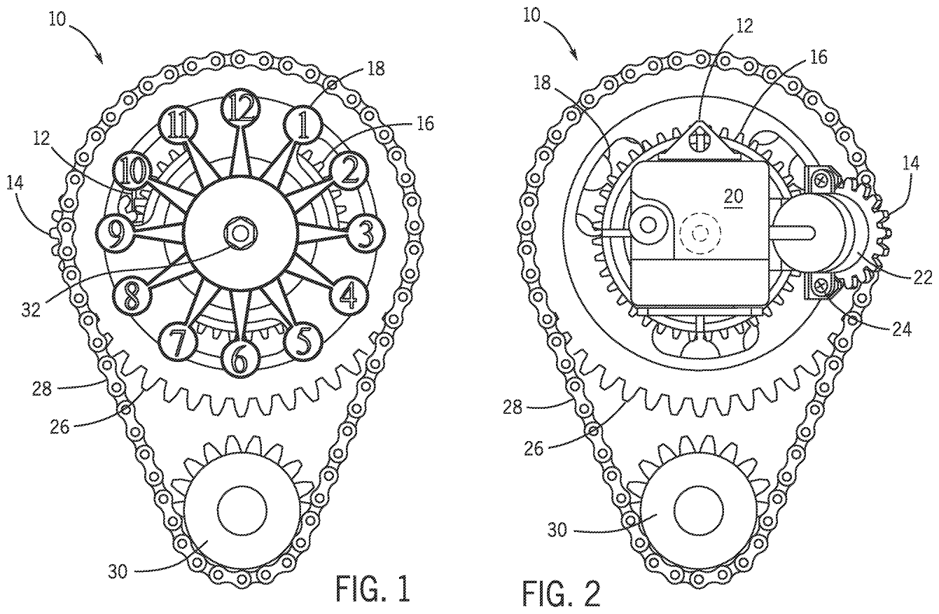

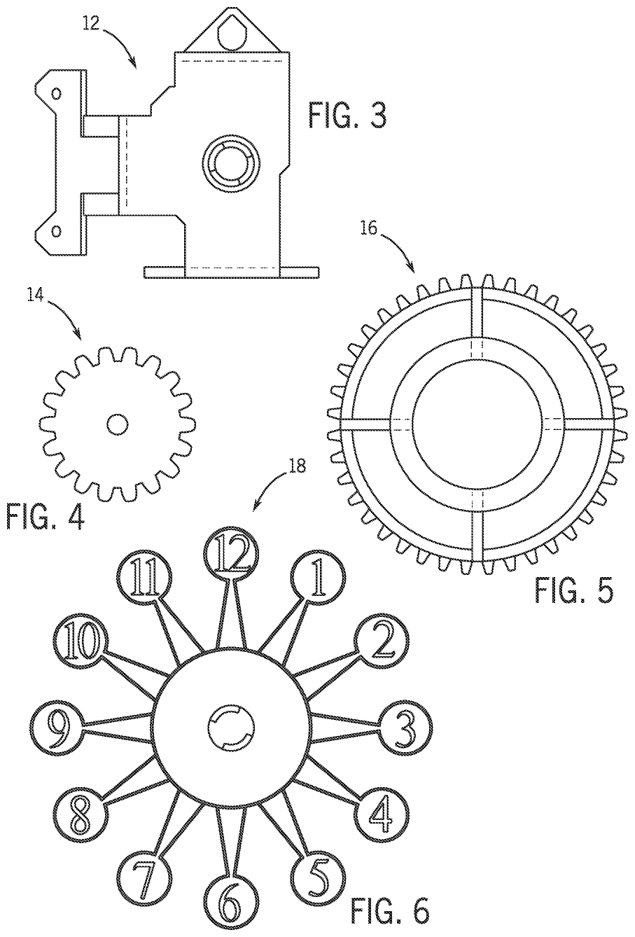

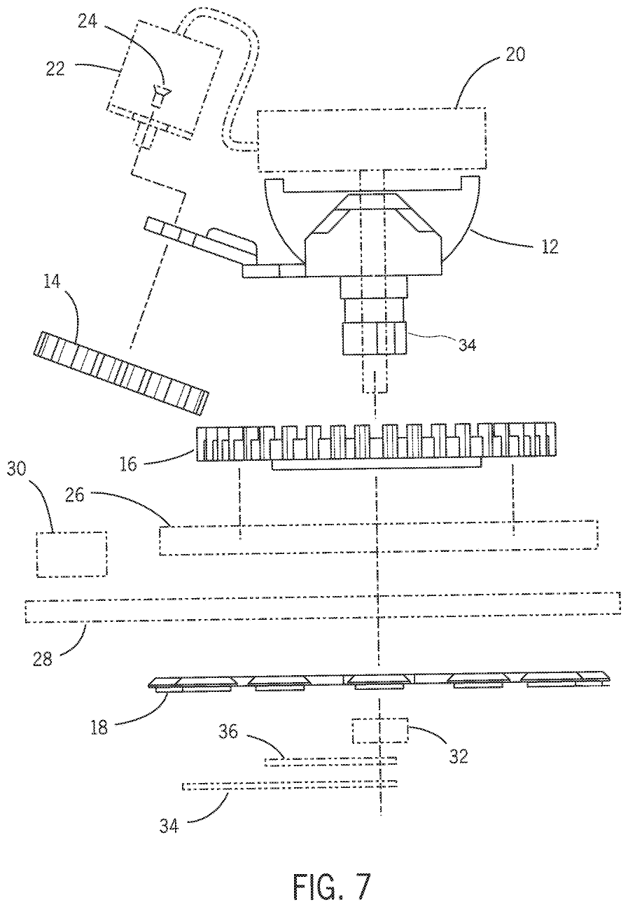

A clock with mechanical parts works motif according to the present invention is show in reference to FIGS. 1-7. The a clock with mechanical movement motif 10 is shown with an automotive part works includes a mount frame 12 which may have an aperture for attachment to a hanger, typically applied to a supporting wall surface. The clock with mechanical movement motif 10 may also include a base and support arm for a free-standing clock coupled withy the mount frame 12.

The clock works 20 may be a modular assembly containing internal gearing, springs, or motors for controlling movements of a spindle 32 for movement of a plurality of conventional clock movement hands, hours 36, minutes 34, and optional second hand. The clock works 20 may be battery powered, electrically powered, or may be a manually wound mechanism. The movement shafts of the clock works spindle 34 is carried through an aperture extending through a clock face 18 and the mounting frame 12. A clock face 18 is coupled with the mounting frame 12 to maintain a stationary position.

The clock with mechanical movement motif 10 includes a drive motor 22 and a drive sprocket 14. The drive sprocket 14 is configured for engagement with a driven sprocket 16 that is coupled with a rotational object 26, such as an automotive gearing. In the non-limiting embodiment, the rotational object 26 is a timing gear 26, such that the timing gear 26 is rotationally carried about the spindle 32. A timing chain 28 is suspended from the timing gear 26 for rotation therewith.

A front face of the mounting frame 12 includes the spindle 34. The spindle 34 may have one or more index notches for cooperative engagement with an indexed bore extending through a clock face 18. The index notches and indexed bore are disposed to maintain an alignment of the clock face 18 with the 12:00 position oriented vertically with the 6:00 position of the clock face 18, when mounted to the mounting frame 12. The spindle 34 also has a shouldered region.

A bushing has an inner diameter that is adapted to be rotationally carried on the shouldered region of the spindle 34. An outer diameter of the bushing is adapted to carry a bore of a rotational body, such as an automotive gear 26. In the non-limiting embodiment shown, the automotive gear 26 is a timing gear sprocket. The timing gear sprocket 26 carries a timing chain 28 suspended thereon. A counterweight, such as a crankshaft sprocket 30 may be suspended at a bottom end of the timing chain 228, such that rotation of the timing sprocket 16 rotates the crankshaft sprocket 30 by movement of the timing chain 28 with the timing gear sprocket 26.

In some embodiments, the clock works 20 may be configured to operatively drives the shouldered region for rotation of the timing gear 26 with a movement of the clock. By way of non-limiting example, the timing chain may be driven by the secondhand shaft of the clock mechanism and a timing mark of the timing chain may provide a visual indication of the seconds indication relative to the clock face 18. In some embodiments, the clock works 20 may include an additional shaft for movement of the timing gear 26 at a predetermined rate relative to the clock. In other embodiments, a control may be provided for adjustment of the predetermined rate.

As will be appreciated, the mechanical parts works may be a bicycle sprocket and chain. In this embodiment, the counterweight may include a bicycle wheel hub. The mechanical parts works may include a plurality of cooperating gear works. The mechanical parts works may also include a hubcap and wheel that is rotationally carried with the movement of the motor 22 and drive sprocket 14.

It should be understood, of course, that the foregoing relates to exemplary embodiments of the invention and that modifications may be made without departing from the spirit and scope of the invention as set forth in the following claims.

What is claimed is:

1. A clock with mechanical movement motif, comprising:
a clock mount adapted for mounting to one or more of a wall surface or an upright stand;
a clock works coupled with the clock mount configured for movement of an hour hand and a minute hand;
a motor having a drive shaft, the motor coupled with the clock mount,
a drive gear attached to the drive shaft of the motor;
a driven sprocket rotationally carried on a spindle, the driven sprocket rotationally operated by engagement with the drive gear; and
a rotational body coupled with the driven sprocket for rotation therewith.

2. The clock of claim 1, further comprising:
a clock face coupled with the clock mount in a fixed orientation with the clock mount in front of a rotational face of the rotational body.

3. The clock of claim 1, wherein the rotational body is an automotive timing gear.

4. The clock of claim 3, further comprising:
a timing chain suspended on the automotive timing gear.

5. The clock of claim 4, further comprising:
an automotive crank gear carried by the automotive timing gear.

6. The clock of claim 1, wherein the rotational body is a bicycle gear.

7. The clock of claim 6, further comprising:
a bicycle chain supported by the bicycle gear.

8. The clock of claim 7, further comprising:
a bicycle hub carried by the bicycle gear.

9. A clock, comprising:
a clock mount adapted for mounting to one or more of a wall surface or an upright stand;
a clock works coupled with the clock mount, the clock works configured for movement of an hour hand and a minute hand;
a motor coupled with the clock mount,
a rotational body coupled with the motor for rotation thereby; and
a clock face maintained in a fixed orientation in front of the rotational body.

10. The clock of claim 9, wherein the rotational body is an automotive timing gear.

11. The clock of claim 10, further comprising:
a timing chain suspended from the automotive timing chain; and
a crank sprocket carried in a free-standing condition by the timing chain.
